(19) United States
(12) Patent Application Publication
(10) Pub. No.: US 2007/0037021 A1
(43) Pub. Date: Feb. 15, 2007

(54) Fuel cell assembly with structural film

(76) Inventors: Peter Szrama, Newark, DE (US); James E. Lagrant, Oxford, PA (US)

Correspondence Address: GORE ENTERPRISE HOLDINGS, INC., 551 PAPER MILL ROAD, P. O. BOX 9206, NEWARK, DE, 19714-9206, US

(21) Appl. No.: 11/585,443

(22) Filed: Oct. 23, 2006

Related U.S. Application Data
(62) Division of application No. 10/910,474, filed on Aug. 3, 2004.

(51) Int. Cl. H01M 8/00

(52) U.S. Cl. 429/12

(57) ABSTRACT

An assembly for use in a fuel cell comprising a first membrane having an inner portion and an outer peripheral portion; a second membrane having a corresponding inner portion to the inner portion of the first membrane, and a corresponding outer peripheral portion to the outer peripheral portion of the first membrane; a structural film layer disposed between at least part of the outer peripheral portion of first membrane and the corresponding outer peripheral portion of the second membrane; and the inner portion of the first membrane contacting the corresponding inner portion of the second membrane to provide ionic communication between the first membrane and the second membrane. The structural film provides added strength and stability to the assembly.

### RELATED APPLICATION

The present application is a divisional application of U.S. patent application Ser. No. 10/910,244 filed Aug. 3, 2004.

### FIELD OF THE INVENTION

This invention pertains to polymer electrolyte membrane cells and, more particularly, to a structural film for use with a polymer electrolyte membrane in a fuel cell.

### BACKGROUND OF THE INVENTION

A central component of a polymer electrolyte membrane fuel cell is the ion exchange membrane. Typically, the membrane is disposed between an anode and a cathode. The membrane facilitates the transmission of ions from one electrode to the other during operation of the fuel cell. Ideally, the membrane is as thin as possible to allow the ions to travel as quickly as possible between the electrodes. As membranes get thinner, however, they typically get weaker. Therefore, reinforcement of the membrane is needed. One solution to this is the incorporation of a reinforcement within the membrane. An example of such a solution is embodied in U.S. Pat. No. RE37,307 to Bahar et al, disclosing the use of a porous material such as expanded PTFE as a support for a membrane.

There is a need, however, for even further reinforcement of a membrane in certain situations. When a membrane is used in an assembly that includes gas diffusion layers, which are typically made of carbon fiber paper, the carbon fibers are known to occasionally puncture the membrane, thereby short circuiting the assembly and decreasing or destroying its performance. Puncture of the assembly can occur during the manufacturing process of the assembly itself, or it can occur during the seal molding process due to mold clamping pressures. Puncture can also occur over time during use, or through handling during processing or stack assembly. Protection to the membrane from gas diffusion media fiber puncture is therefore desirable.

Further, additional support for the membrane is frequently necessary to increase overall dimensional stability. Environmental conditions such as humidity, or simply handling of the membrane, may cause damage to the membrane. Additional reinforcement and support to increase this dimensional stability is desired.

A typical attempt to provide such additional support involves the use of peripheral layers on each side (top and bottom) of the membrane surrounding the electrodes. A disadvantage of this approach is that it requires two additional layers that need to be very closely aligned to avoid loss of active area (that part of the electrode that is actually involved in the ion transfer) due to misalignment. There are thus high material and processing costs associated with this design. Adding two layers also adds undesirable thickness to the assembly.

A better assembly is desired that will have structural support for enhanced dimensional stability and protection from puncture, and is also more efficient to produce than existing designs.

As used herein, “assembly” means the combination of at least one membrane and a structural support, but “assembly” may also include other components as well, such as electrodes, gas diffusion media, sealing gaskets, etc.

### SUMMARY OF THE INVENTION

The present invention provides an assembly for use in a fuel cell comprising:
(a) a first membrane having an inner portion and an outer peripheral portion;
(b) a second membrane having a corresponding inner portion to the inner portion of the first membrane, and a corresponding outer peripheral portion to the outer peripheral portion of the first membrane;
(c) a structural film layer disposed between at least part of the outer peripheral portion of first membrane and the corresponding outer peripheral portion of the second membrane; and
(d) the inner portion of the first membrane contacting the corresponding inner portion of the second membrane to provide ionic communication between the first membrane and the second membrane.

In an alternative embodiment, the assembly further includes a cathode on the first membrane and an anode on the second membrane. In a further alternative, a first gas diffusion medium is disposed over the cathode and a second gas diffusion medium disposed over the anode. Preferably, the structural film layer is less than about 0.003 inches thick. Also preferably, the structural film layer is disposed between the entirety of said outer peripheral portion of said first membrane and said corresponding outer peripheral portion of second membrane.

In another embodiment, the invention provides an assembly wherein the outer peripheral portion of the first membrane and the corresponding outer peripheral portion of the second membrane each has an edge, each of the edges extending substantially coextensively, wherein the structural film layer is flush with the edges, and wherein a sealing gasket is disposed on at least one end of the assembly and is integrally attached to the first membrane, the second membrane, and the structural film layer.

In another embodiment, the outer peripheral portion of the first membrane and the corresponding outer peripheral portion of the second membrane each has an edge, each of said edges extending substantially coextensively, and wherein the structural film layer extends beyond said edge and optionally has a sealing gasket disposed on at least one side thereof.

In another embodiment, the invention provides an assembly for use in a fuel cell comprising:
(a) a membrane having an inner portion and an outer peripheral portion;
(b) a structural film layer covering at least part of the outer peripheral portion of the membrane.
   In this embodiment, then assembly optionally further includes an anode disposed on a first side of the membrane and a cathode disposed on a second side of the membrane. A gas diffusion medium is also optionally disposed over at least one of the anode and the cathode.

In another aspect, the invention provides a method of making a plurality of discrete assemblies for use in fuel cells comprising the steps of:
(a) providing a first membrane having a cathode disposed thereon;
(b) providing a second membrane having an anode disposed thereon;
(c) providing a structural film layer defining a plurality of windows;
(d) laminating the first membrane to said second membrane in a continuous process with the structural film layer therebetween, such that the first membrane contacts said second membrane within the windows to provide ionic communication between the first membrane and the second membrane and to form a plurality of continuous assemblies; and
(e) cutting the continuous membrane electrode assemblies to form the plurality of discrete assemblies.

### BRIEF DESCRIPTION OF THE DRAWINGS

FIG. 1 is a schematic illustration of an assembly manufacturing process according to an exemplary embodiment of the present invention.

FIG. 1a is a plan view of a portion of a continuous structural film layer according to an exemplary embodiment of the present invention.

FIG. 2 is an exploded cross-sectional view of an assembly according to an exemplary embodiment of the present invention.

FIG. 3 is a cross-sectional view of the assembly of FIG. 2, not exploded.

FIG. 3A is a plan view of the assembly of FIG. 3.

FIG. 4 is a schematic illustration of an assembly manufacturing process according to an exemplary embodiment of the present invention.

FIG. 5 is an exploded cross-sectional view of an assembly according to an exemplary embodiment of the present invention.

FIG. 6 is a cross-sectional view of the assembly of FIG. 5, not exploded.

FIG. 7 is a schematic illustration of an assembly manufacturing process according to an exemplary embodiment of the present invention.

FIG. 8 is an exploded cross-sectional view of an assembly according to an exemplary embodiment of the present invention.

FIG. 9 is a cross-sectional view of the assembly of FIG. 8, not exploded.

FIG. 10 is a plan view of the assembly illustrated in FIG. 9.

FIG. 11 is an exploded cross-sectional view of an assembly according to an exemplary embodiment of the present invention.

FIG. 12 is a cross-sectional view of the assembly of FIG. 11, not exploded.

FIG. 13 is a plan view of the assembly illustrated in FIG. 12.

FIG. 14 is an exploded cross-sectional view of an assembly according to an exemplary embodiment of the present invention.

FIG. 14A is an exploded cross-sectional view of an assembly according to an exemplary embodiment of the present invention.

### DETAILED DESCRIPTION OF THE INVENTION

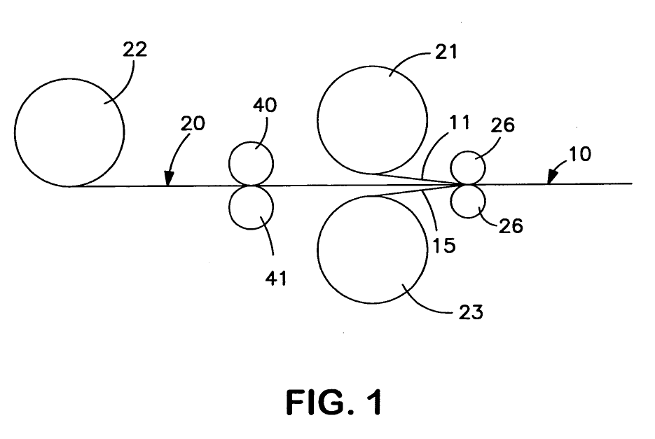

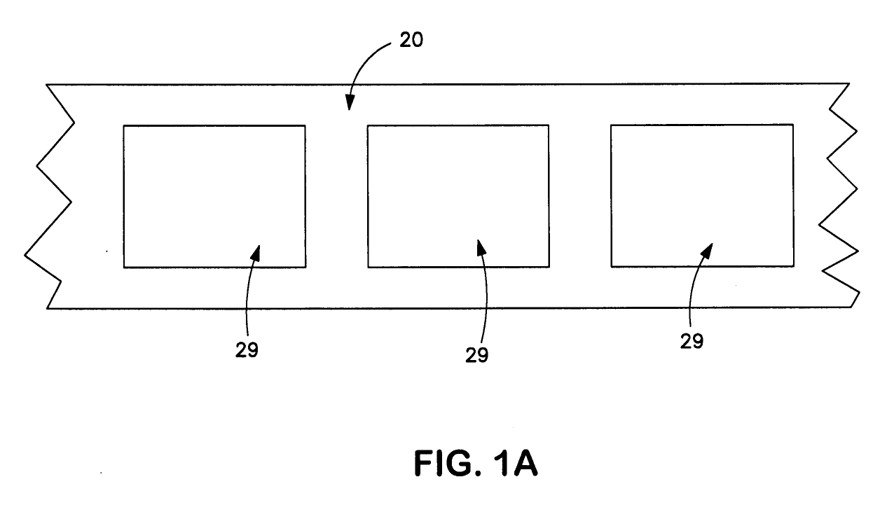

FIG. 1 illustrates a process for producing an assembly 10 according to an exemplary embodiment of the present invention. A first membrane 11 is paid off of a first membrane spool 21. A second membrane 15 is paid off a second membrane spool 23. The two membranes are sandwiched together by rollers 26 with structural film layer 20 therebetween. As used herein, “structural film layer” means hard, non-elastomeric polymers. Such polymers include, but are not limited to PEN (polyethylene naphthalate), non-porous polypropylene, polystyrene, rigid polyvinylchloride, polyamides, acylonitrile-butadiene-styrene (ABS) copolymer, polyamides, acrylics, acetals, hard cellulosics, polycarbonates, polyesters, phenolics, urea-milamines, polyesters, epoxies, urethanes, and glass filled silcone thermosets. Non-elastomeric polymers as used herein are polymers that will not return to their original length after being stretched repeatedly to at least twice their original length at room temperature. In a preferred embodiment, structural film layer 20 is formed of PEN. Preferably, structural film layer 20 is less than about 0.003 inches thick. Also preferably, structural film layer 20 has an adhesive in it or on at least one of its surfaces to promote bonding to the membrane. Any suitable adhesive can be used, but PVAc (polyvinylacetate) is preferred.

Specifically, as shown in FIG. 1a, structural film layer 20 in its continuous form after it is die-cut comprises a series of openings 29 formed therein. Openings 29 are windows that have been cut from structural film layer 20. Openings 29 are of any shape but substantially square or rectangular cuts are preferred. Openings 29 define the active area for the assembly. As first membrane 11 and second membrane 15 are sandwiched on either side of structural film layer 20, first membrane 11 and second membrane 15 contact and bond to one another through opening 29. They are thus in ionic communication with one another in the active area. Structural film layer 20 is present to promote the structural integrity of assembly 10 for dimensional stability and to protect it from puncture and other damage. It is not compressible to any significant degree. Its function is not to perform any sealing

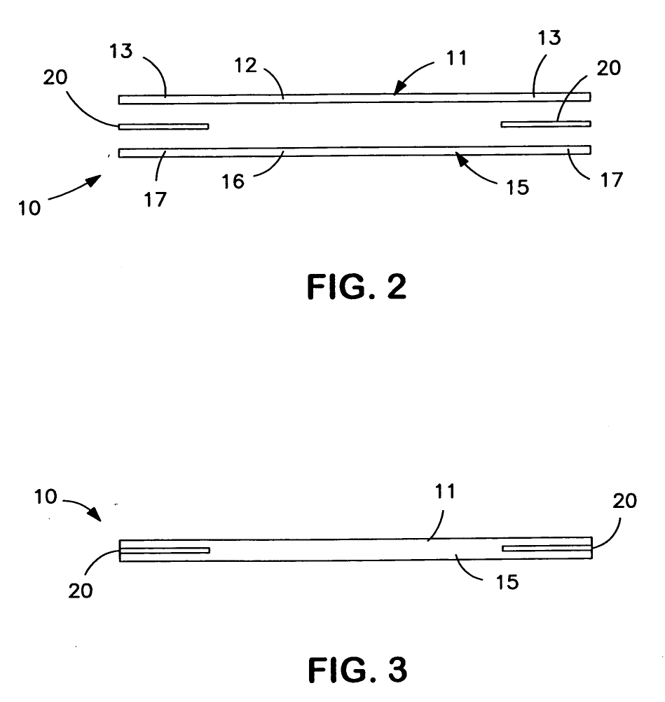

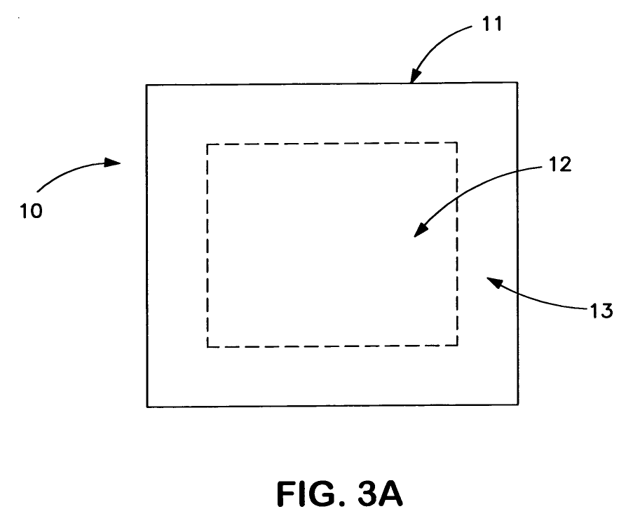

Referring back to FIG. 1, as assemblies 10 are produced according to the exemplary process, the continuous length of assemblies produced by the illustrated process are cut (by a device not shown in FIG. 1) into discrete, individual assemblies. Specifically, with reference to FIG. 2, an individual assembly that has been produced and cut according to the process illustrated in FIG. 1 is shown. Membrane 11 has an inner portion 12 and an outer peripheral portion 13. Second membrane 15 has an inner portion 16 corresponding to the inner portion 12 of first membrane 11. Second membrane 15 also has an outer peripheral portion 17 corresponding to outer peripheral portion 13 of first membrane 11. Structural film 20 is disposed between first membrane 11 and second membrane 15 at the outer peripheral portions 13, 17 of the membranes. Inner portions 12, 15 are in ionic communication through window 29 of structural film layer 20. FIG. 2 is an exploded view of the assembly cross section; FIG. 3 is a completed view of an exemplary assembly 10 showing the exploded parts illustrated in FIG. 2 in final form.

Producing the assembly shown in FIG. 3 with a single, internal structural film layer not only provides similar benefits to the product having two layers of structural material but also has significant improvements relative to the two layer approach. The single layer method described herein furnishes the desired edge protection, part stability, and pressure to short resistance necessary for processsing and continuous, long life, performance in a fuel cell. Additionally, the single layer approach eliminates active area alignment tolerance considerations resulting from placement of a second layer adjacent to or over an electrode. It also reduces processing and material costs. Placing the protective layer along the centerline of the part also provides a balanced assembly (same number of layers on both sides) which provides flat, dimensionally stable constructions that do not curl due to the hydroscopic nature of the membrane material.

FIG. 3a shows a plan view of the assembly 10 from FIG. 3. First membrane 11 is visible having inner portion 12 and outer portion 13. Not shown (because it is on the underside of first membrane 11) is second membrane 15 having corresponding outer portion 17 and corresponding inner portion 16. The dashed line in FIG. 3a is used simply to illustrate the division between the inner portion 12 and the outer peripheral portion 13. In use, the outer peripheral portion 13 is defined by the presence of structural film 20, which is located between the outer peripheral portions of first membrane 11 and second membrane 15 and inner portion 12 is defined by window 29. First membrane 11 and second membrane 15 are bonded together at inner portions 12, 16 such that ions can freely transfer between first membrane 11 and second membrane 15. First membrane 11 and second membrane 15 are thus in ionic communication.

In an exemplary embodiment, first membrane 11 and second membrane 15 are made of the same material, but said first and second membrane may also comprise different ionomers, or comprise different equivalent weights of the same ionomer. Preferably this material comprises an expanded polytetrafluorooethylene (ePTFE) support having pores (pores are defined herein as interconnected passages and pathways) which are substantially occluded by ionic exchange resin. Ionic exchange resin present of first membrane 11 contacts ionic exchange resin of second membrane 15, thus resulting in the bonding of first membrane 11 to second membrane 15 at their corresponding inner portions 12, 16.

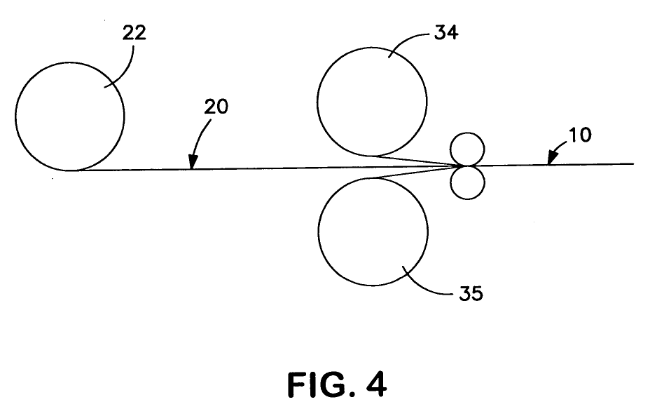

FIG. 4 shows an alternative embodiment of the present invention. In this exemplary embodiment, a one sided catalyst coated membrane is provided on spool 34. (In the illustrated embodiment, the catalyst that is coated on the membrane on spool 34 functions as a cathode electrode.) The production of the catalyst coated membrane is done according to methods known in the art, such as that disclosed in U.S. Pat. No. 6,054,230 to Kato. Alternative methods for assembling a catalyst coated membrane are also known in the art. Another catalyst coated membrane, also produced according to methods known in the art, is wound on spool 35. (The catalyst here functions as an anode electrode.) The anode and cathode are illustrated on bottom and top, respectively, in this embodiment, but they could be reversed. The two catalyst coated membranes are then paid off of spools 34 and 35, respectively, and sandwiched around structural film 20, which has a configuration similar to that shown in FIG. 1a. This forms an assembly 10, which in this case is a membrane electrode assembly (as opposed to simply a membrane assembly as described above). The continuous MEAs that are produced according to the process of FIG. 4 are then cut into individual MEAs by any cutting device (not shown) known in the art. Such cutting devices may include, but are not limited to, die cutters, knives, water jet cutters, lasers, etc.

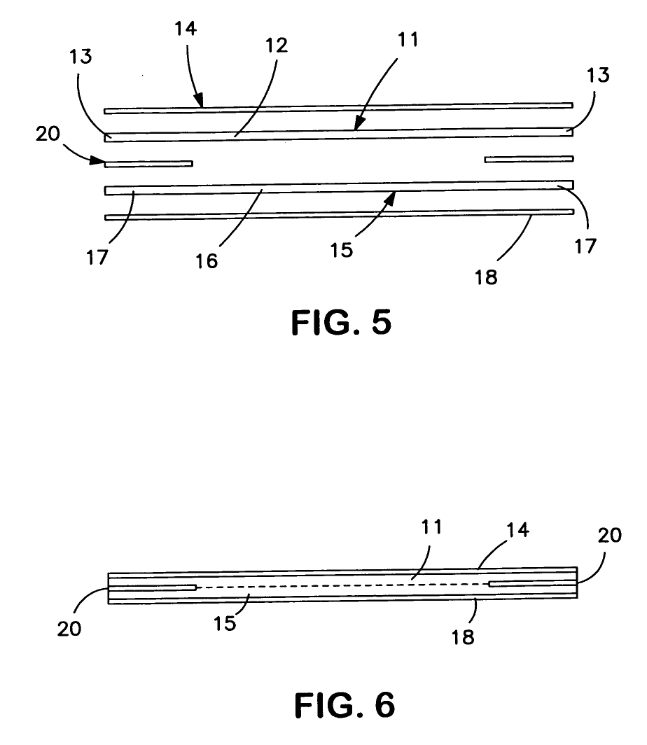

FIG. 5 shows an exemplary exploded cross-sectional view of an assembly 10 produced according to the exemplary process of FIG. 4. Cathode 14 is bonded to first membrane 11 and anode 18 is bonded to second membrane 15. First membrane 11 and second membrane 15 are then sandwiched together around protective film 20 as described above, with corresponding inner portions 12 and 16 bonded together in ionic communication and corresponding outer peripheral portions 13 and 17 having protective film 20 therebetween.

FIG. 6 shows a completed assembly 10 containing the various parts illustrated in FIG. 5 in final form.

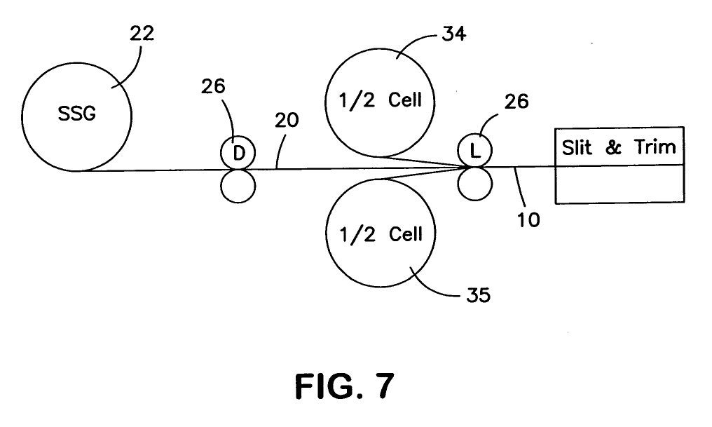

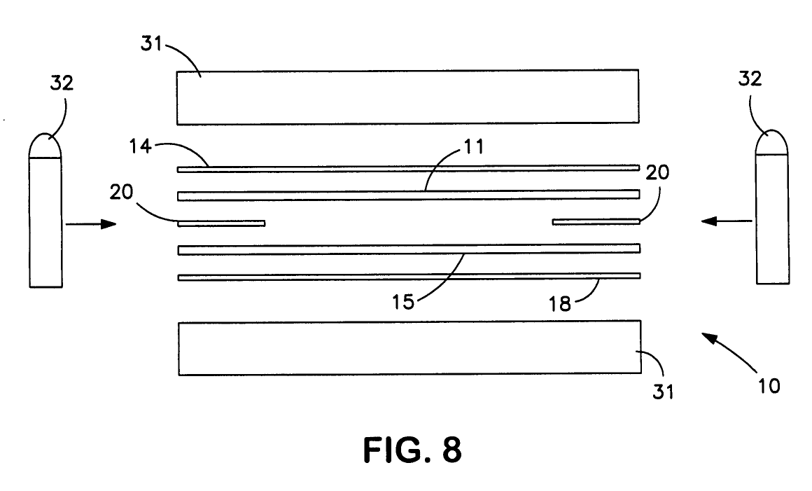

FIG. 7 illustrates another alternative exemplary embodiment of the present invention. In this embodiment, spool 34 is a catalyst coated membrane that also has a gas diffusion medium 31 thereon (see FIG. 8). Gas diffusion medium 31 is any gas diffusion medium known in the art that preferably adheres to the electrode. Preferably, gas diffusion medium 31 is itself a combination of a “macro” gas diffusion medium, such as carbon paper, and a “micro” gas diffusion medium, such as a thin layer of carbon-filled PTFE. This “micro” gas diffusion layer can be a fee-standing layer; for example, CARBEL™ MP gas diffusion layer, available from W.L. Gore & Associates. Gas diffusion medium 31 is laminated to cathode 14 (again according to methods known in the art), which is laminated to first membrane 11. Gas diffusion medium 31, cathode 14, and first membrane 11, are then wound together to form a half MEA on half MEA spool 34. A gas diffusion medium 31 is also laminated to the anode 18 in a similar manner. The anode side is wound into a half MEA on half MEA spool 35. The corresponding half MEAs are then paid off of half MEA spools 34 and 35 and sandwiched on either side of structural film 20 as described previously. This forms a continuous assembly 10 which can then be cut into individual assemblies using device (not shown).

One such exemplary individual assembly made by the process illustrated in FIG. 7 is illustrated in FIG. 8. In this exemplary embodiment, the assembly further includes a sealing gasket 32. Sealing gasket 32 is preferably made of compressible material such as silicone EPDM or alternatively fluoropolymer material but could be any material that performs the function of sealing gases inside assembly 10 during use in a fuel cell. In the embodiment of FIG. 8, sealing gasket 32 is molded onto the laminated structure. Specifically, gas diffusion media 31 are shown to be disposed on the outer surfaces of cathode 14 and anode 18, respectively. Cathode 14 is bonded to first membrane 11 and anode 18 is bonded to second membrane 15. First membrane 11 and second membrane 15 are sandwiched together having structural film 20 therebetween as described above. Sealing gasket 32 is then molded around the assembly. Preferably, sealing gasket 32 surrounds the whole assembly, but it could alternatively be present on fewer than all sides. Also alternatively, sealing gasket 32 may be formed by filling the edges of the gas diffusion media.

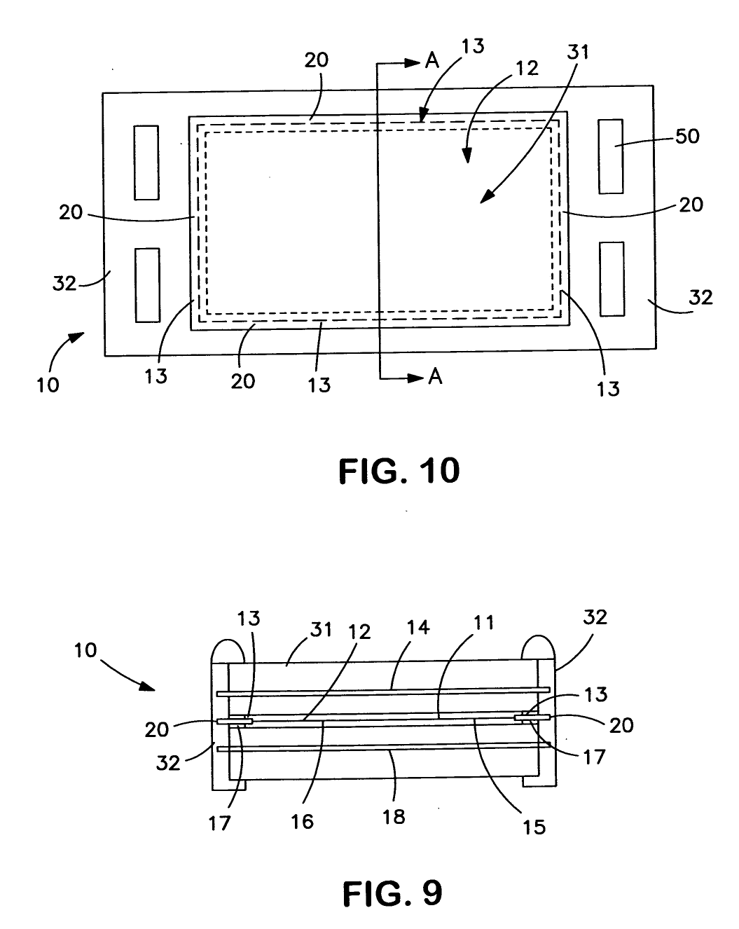

A completed version of this exemplary embodiment is illustrated in FIG. 9. Sealing gasket 32 is shown to be integrally molded onto the edges of gas diffusion media 31, electrodes 14, 18, membranes 11, 15, and structural film layer 20 (the edges of which all extend substantially coextensively in this embodiment). In this embodiment, gas diffusion media 31 hold electrodes 14, 18 and membranes 11, 15 in check during the molding process and provide a rigid support and dimensionally stable media in which to mold sealing gasket 32 onto. FIG. 10 is a plan view of the assembly shown in FIG. 9. (FIG. 9 is a cross sectional view taken along section AA of FIG. 10). Gas diffusion medium 31 actually covers inner portion 12 and outer peripheral portion 13 of first membrane 11 (with cathode 14 disposed therebetween in this embodiment). Structural film layer 20 is located under peripheral outer portion 13. Sealing gasket 32 is disposed around the outside edges of these components. In the illustrated embodiment, sealing gasket 32 has raised portions which enhance the compression and sealing function of the component. Gas flow openings 50 are also provided in this exemplary embodiment in sealing gasket 32 to allow for gas flow when used in the fuel cell.

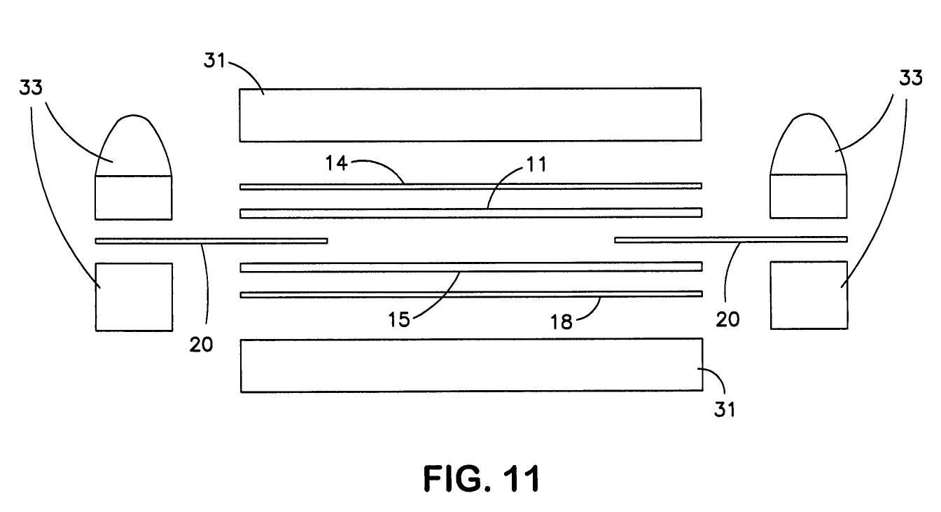

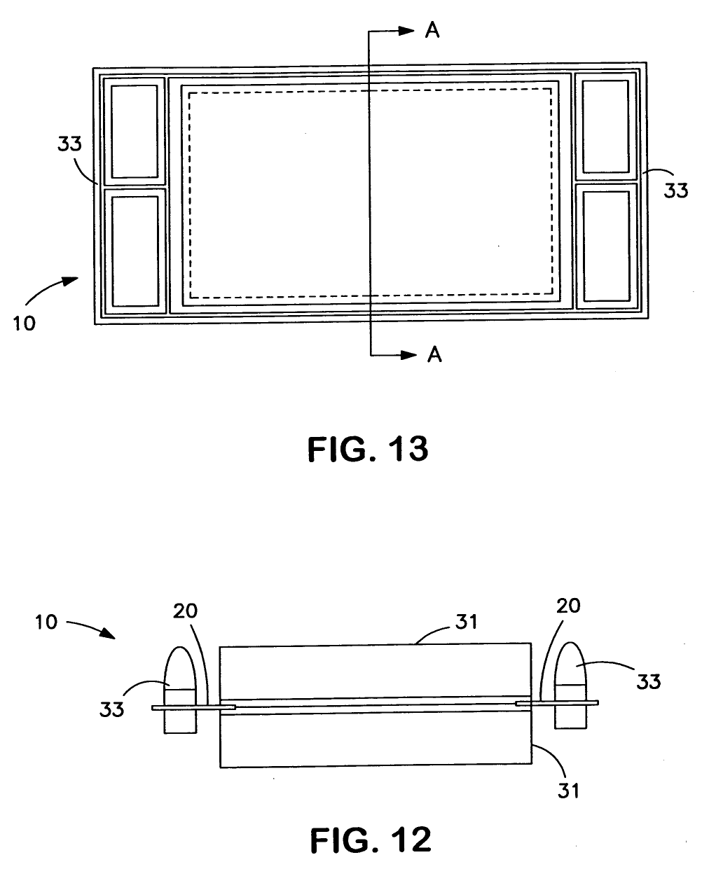

In another alternative embodiment of the present invention, an assembly 10 may be produced as described above having the structure shown in FIG. 11. Specifically in this embodiment, structural film 20 extends beyond the edges of first and second membranes 11 and 15 and cathode 14 and anode 18. In the illustration, an optional sealing gasket 33 has been premolded onto the portion of structural film 20 that extends beyond the edges. Sealing gasket 33, if it is used, performs the same function as sealing gasket 32 of the previous embodiment. The completed version of this embodiment is shown in FIG. 12. FIG. 13 shows a plan view of the assembly of FIG. 12 (FIG. 12 is a cross-sectional view taken along section AA of FIG. 13).

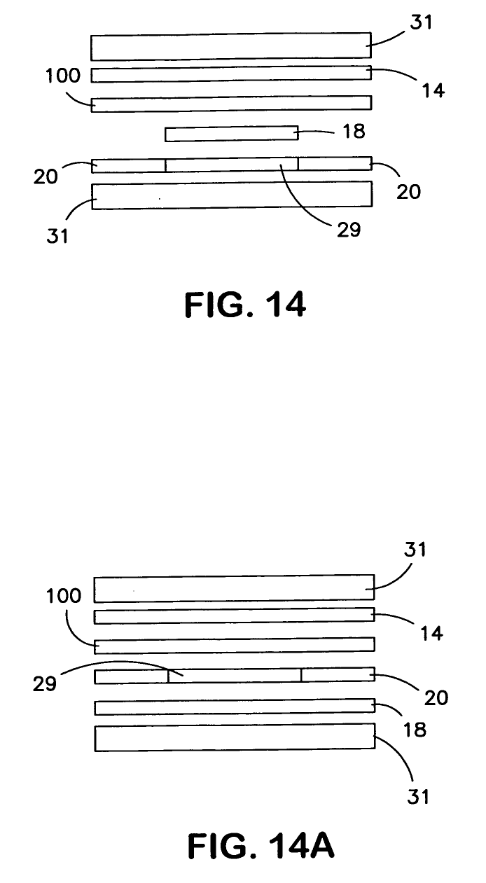

Yet another embodiment of the invention is illustrated in FIG. 14, which is an exploded view. In this embodiment, a single membrane 100 is used. It has anode 18 and cathode 14 disposed thereon as described above. In this embodiment, however, structural film layer 20 is located on one side of membrane 100. In the illustrated embodiment, it is adjacent to anode 18 but could be adjacent to cathode 14. In the final assembly, when the parts are pressed together, anode 18 fits through window 29 of structural film layer 20, such that structural film layer 20 is directly adjacent membrane 100 around the outer peripheral portion thereof. Gas diffusion media 31 sandwich the structure to form the final assembly in the illustrated embodiment.

Also alternatively, as illustrated in FIG. 14A, anode 18 (or cathode 14), may be deposited over structural film layer 20. This embodiment eliminates alignment considerations needed with the embodiment of FIG. 14. In the final assembly of this embodiment, anode 18 is actually pressed into window 29 of structural film layer 20 to contact membrane 100.

In all of the illustrated embodiments, significant improvements are provided by structural film 20. It protects the membrane and provides structural support as described above, which produces a more durable, long-lasting assembly for fuel cells.

While the present invention has been described in connection with certain preferred embodiments, the scope of the invention is not intended to be limited thereby. Rather, the invention is to be given the scope defined in the appended claims.

The invention claimed is:

1. An assembly for use in a fuel cell comprising:
(a) a first membrane having an inner portion and an outer peripheral portion;
(b) a second membrane having a corresponding inner portion to said inner portion of said first membrane, and a corresponding outer peripheral portion to said outer peripheral portion of said first membrane;
(c) a structural film layer disposed between at least part of said outer peripheral portion of said first membrane and said corresponding outer peripheral portion of said second membrane; and
(d) said inner portion of said first membrane contacting said corresponding inner portion of said second membrane to provide ionic communication between said first membrane and said second membrane.

2. An assembly as defined in claim 1 further comprising a cathode on said first membrane and an anode on said second membrane.

3. An assembly as defined in claim 1 wherein said structural film layer is less than about 0.003 inches thick.

4. An assembly as defined in claim 1 wherein said outer peripheral portion of said first membrane and said corresponding outer peripheral portion of said second membrane each has an edge, each of said edges extending substantially coextensively, and wherein said structural film layer is flush with said edges.

5. An assembly as defined in claim 1 wherein said outer peripheral portion of said first membrane and said corresponding outer peripheral portion of said second membrane each has an edge, each of said edges extending substantially coextensively, and wherein said structural film layer extends beyond said edge and optionally has a sealing gasket disposed on at least one side thereof.

6. An assembly as defined in claim 1 wherein said outer peripheral portion of said first membrane and said corresponding outer peripheral portion of said second membrane and said structural film layer each has an edge, each of said edges extending substantially coextensively, and wherein a sealing gasket is disposed on at least one edge of said assembly and is integrally attached to said first membrane, said second membrane, and said structural film layer.

7. An assembly as defined in claim 1 wherein said structural film layer is disposed between the entirety of said outer peripheral portion of said first membrane and said corresponding outer peripheral portion of second membrane.

8. An assembly as defined in claim 2 further comprising a first gas diffusion medium disposed over said cathode and a second gas diffusion medium disposed over said anode.

9. An assembly as defined in claim 8 wherein said outer peripheral portion of said first membrane, said corresponding outer peripheral portion of said second membrane, said structural film layer, said first gas diffusion medium, and said second gas diffusion medium each has an edge, each said edge extending substantially coextensively, and wherein a sealing gasket is integrally attached at said edge to said first membrane, said second membrane, said structural film layer, said first gas diffusion medium, and said second gas diffusion medium.
